(19) United States
(12) Patent Application Publication
(10) Pub. No.: US 2025/0148387 A1
(43) Pub. Date: May 8, 2025

(54) SYSTEM AND METHOD FOR AUTO-APPROVING PENDING REQUESTS OF AGENTS BASED IN A DYNAMIC ENVIRONMENT

(71) Applicant: NICE LTD., Ra’anana (IL)

(72) Inventors: Sanyog MISHRA, Pune (IN); Rajesh GUPTA, Lucknow (IN); Bibek POUDEL, Pune (IN)

(21) Appl. No.: 18/502,814

(22) Filed: Nov. 6, 2023

(51) Int. Cl. G06Q 10/0631

(52) U.S. Cl. CPC G06Q 10/063116

(57) ABSTRACT

Systems adapted to auto-approve pending requests of contact center agents based in a dynamic environment and methods, and non-transitory computer readable media, include monitoring operational parameters affecting staffing needs and automatic approval criteria; establishing that a new staffing situation is present based on the monitored operational parameters, automatic approval criteria, or both; determining that the new staffing situation meets a current staffing threshold; identifying a pending schedule change request submitted by a contact center agent; comparing the identified pending schedule change request with the automatic approval criteria; updating a schedule of the contact center agent based on the approved identified pending schedule change request or approved generated recommendation; and sending a schedule notification to the contact center agent.

### COPYRIGHT NOTICE

A portion of the disclosure of this patent document contains material which is subject to copyright protection. The copyright owner has no objection to the facsimile reproduction by anyone of the patent document or the patent disclosure, as it appears in the U.S. Patent and Trademark Office patent file or records, but otherwise reserves all copyright rights whatsoever.

### TECHNICAL FIELD

The present disclosure relates generally to methods and systems of schedule change management, and more specifically relates to methods and systems to auto-approve pending schedule change requests in response to changes in staffing needs in a dynamic environment, based on changes in staffing requirements and/or in approval criteria.

### BACKGROUND

The subject matter discussed in this background section should not be assumed to be prior art merely as a result of its mention herein. Similarly, a problem mentioned in this background section or associated with the subject matter of the background section should not be assumed to have been previously recognized (or be conventional or well-known) in the prior art. The subject matter in this background section merely represents different approaches, which in and of themselves may also be inventions.

Efficiency and adaptability in schedule change management is critical for any contact center organization. An important aspect of schedule change management includes attention to schedule change requests from employees (contact center agents). Schedule change requests may be submitted by an agent seeking to work extra hours, request time off, exchange their shift with the shift of another agent, etc. Currently, processing such schedule change requests from contact center agents typically requires some sort of manual intervention (such as manual approval) by a contact center supervisor or administrator.

Management of these requests can be time-intensive for contact center supervisors, who upon receiving a schedule change request, may be required to manually check staffing situations for a number of shifts prior to approving the schedule change request. Staffing situations change dynamically as various change requests are entered and organization workflow conditions change themselves. For organizations with a large number of agents and/or employees, there can be hundreds or thousands of schedule change requests, such that a supervisor may not be able to address each request in a timely manner, leading to missed opportunities for agents and increased costs for the organization.

There exist methods involving self-service modules spanning from simple requests to automated pre-approvals, however, those methods require some level of manual intervention in order to respond to changes in staffing situations. These existing methods lack a multilayered approach capable of auto-approving schedule change requests in response to changes in staffing situations after the schedule change request has been sent and is still pending. For example, the approval process of a pending schedule change request submitted prior to a shift suddenly becoming understaffed may not take into account the staffing situation change if the approval process cannot take into account the newly opened shift positions as a result of the change. Or, schedule change requests sent by two different agents to two different supervisors may experience differences in timeliness of approval, which may cause an earlier submitted request to still be processed later, and may cause that agent who made the first request to lose the opportunity to get more hours.

Accordingly, there is a need for a system that can streamline the approval process for schedule change requests such that pending requests may be auto-approved in response to changes in staffing needs in a dynamic environment, based on changes in staffing requirements and/or in approval criteria.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion. In the figures, elements having the same designations have the same or similar functions.

FIG. 1 is a simplified data flow in a system according to various aspects of the present disclosure.

FIG. 2 is a flowchart of a method of schedule change management according to embodiments of the present disclosure.

FIG. 3 illustrates an exemplary user notification that allows an agent to view recommendations generated by the system according to embodiments of the present disclosure.

FIG. 4 illustrates an exemplary user interface that allows a user to create a self-service template within the schedule change management system according to embodiments of the present disclosure.

FIG. 5 illustrates an exemplary user interface that allows a user to view and make one or more templates active or inactive according to embodiment of the present disclosure.

FIG. 6A illustrates an exemplary user interface that allows a user to view shift interval data in schedule management system according to embodiments of the present disclosure.

FIG. 6B illustrates exemplary user interface displaying changes in shift interval availability status after a new staffing situation has occurred according to embodiments of the present disclosure.

### DETAILED DESCRIPTION

This description and the accompanying drawings that illustrate aspects, embodiments, implementations, or applications should not be taken as limiting—the claims define the protected invention. Various mechanical, compositional, structural, electrical, and operational changes may be made without departing from the spirit and scope of this description and the claims. In some instances, well-known circuits, structures, or techniques have not been shown or described in detail as these are known to one of ordinary skill in the art.

In this description, specific details are set forth describing some embodiments consistent with the present disclosure. Numerous specific details are set forth in order to provide a thorough understanding of the embodiments. It will be apparent, however, to one of ordinary skill in the art that some embodiments may be practiced without some or all of these specific details. The specific embodiments disclosed herein are meant to be illustrative but not limiting. One of ordinary skill in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

The systems and methods described herein relate to schedule change management. In various embodiments, changes in staffing requirements of shift intervals for a contact center schedule are kept track of by monitoring operational parameters affecting staffing needs as well as automatic approval criteria. Based on the monitored operational parameters, automatic approval criteria, or both, a new staffing situation may be established as present, potentially causing changes to the availability status of one or more shift intervals. If it is determined that a new staffing situation has met a current staffing threshold such that the availability status of a shift interval has changed, a pending schedule change request submitted by a contact center agent may be identified and compared with automatic approval criteria. When the identified pending schedule change request meets the automatic approval criteria, the identified pending schedule change request is automatically approved. When the identified pending schedule change request does not meet the automatic approval criteria, but a portion of the identified pending schedule change request does meet the automatic approval criteria, a recommendation for the identified pending schedule change request is generated and transmitted to the contact center agent who submitted the identified pending schedule change request. If an approval of the generated recommendation from the contact center agent is received, the generated recommendation is automatically approved, and the identified pending schedule change request is canceled. A schedule of the contact center agent is updated based on the approved identified pending schedule change request or the approved generated recommendation, and a schedule notification is sent to the contact center agent. In some embodiments, the schedule notification may be sent to the supervisor of the contact center agent.

In various embodiments, operational parameters may include one or more of unplanned absenteeism (for any reason, e.g., medical visit, illness, walking off the job, etc.), contact volume inflow, skills needed, understaffing, overstaffing, or any combination thereof.

In certain embodiments, generating a recommendation for the identified pending schedule change request includes generating revisions to the identified pending schedule change request to meet the automatic approval criteria. These revisions may comprise a change to a time interval range in the identified pending schedule change request.

In several embodiments, when the identified pending schedule change request does not meet the automatic approval criteria and a recommendation for the identified pending schedule change request is generated, then transmitted to and approved by the contact center agent, the identified pending schedule change request may be canceled. When the identified pending schedule change request does meet automatic approval criteria, the status of the identified pending schedule change request may be changed to automatically approved.

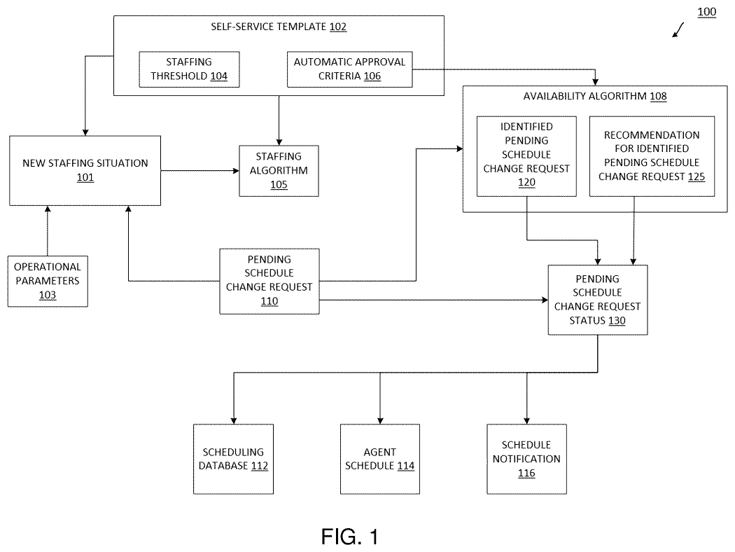

FIG. 1 illustrates data flow in an example schedule management system 100 according to some embodiments of the present disclosure. As shown, schedule management system 100 may include or implement a plurality of devices, servers, and/or software components that operate to perform various methodologies in accordance with the described embodiments. Exemplary devices and servers may include device, stand-alone, and enterprise-class servers, operating an operating system (OS) such as a MICROSOFT® OS, a UNIX® OS, a LINUX® OS, or another suitable device and/or server-based OS. It will be appreciated that the devices and/or servers illustrated in FIG. 1 may be deployed in other ways and that the operations performed, and/or the services provided, by such devices and/or servers may be combined or separated for a given embodiment and may be performed by a greater number or fewer number of devices and/or servers. For example, machine learning (ML), neural network (NN), and other artificial intelligence (AI) architectures have been developed to improve predictive analysis and classifications by systems in a manner similar to human decision-making, which increases efficiency and speed in performing predictive analysis of transaction data sets. One or more devices and/or servers may be operated and/or maintained by the same or different entities.

As shown, data in schedule management system 100 includes new staffing situation 101, operational parameters 103, self-service template 102, staffing threshold 104, automatic approval criteria 106, staffing algorithm 105, pending schedule change request 110, availability algorithm 108, identified pending schedule change request 120, recommendation for identified pending schedule change request 125, pending schedule change request status 130, scheduling database 112, agent schedule 114, and schedule notification 116.

At any given point in time, schedule management system 100 may receive one or more pending schedule change request(s) 110 (also referred to as pending request 110) submitted by one or more contact center agents. In one or more embodiments, these pending request(s) 110 may correspond with a time-based shift interval for which the agent, for example without limitations, is scheduled to work, wishes to request time off, will not be able to work, or wishes to work.

In one or more embodiments, schedule management system 100 may categorize time-based shift intervals as having full, limited, or no availability. Pending requests 110 submitted for intervals with full availability may be auto-approved by schedule management system 100, without need for supervisor action. Pending request 110 submitted for intervals with limited availability require manual supervisor approval and/or revisions to pending request 110 such that it is submitted for an interval with full availability. For example, if a pending request 110 is received for a shift interval from 9:00:00 AM-11:00:00 AM, and the shift interval from 9:00:00 AM-10:00:00 AM has full availability while the shift interval from 10:00:00 AM-11:00:00 AM has limited availability, the pending request 110 will either need manual supervisor approval to be approved for the shift interval from 9:00:00 AM-11:00:00 AM, or will need to be revised to cover the shift interval from 9:00:00 AM-10:00:00 AM such that the pending request 110 may be auto-approved. In some embodiments, pending requests 110 submitted for intervals with no availability may be cancelled and/or automatically rejected.

In some embodiments, a background self-service scheduler (not shown) may categorize pending requests 110 by their approval type, based on the shift interval for which they have been submitted. For example, pending requests 110 requiring manual approval by a contact center supervisor may be labeled as “approval-required” type. In some embodiments, a pending request 110 may be labeled as “auto-approve” type if a new staffing situation 101 is present as described below. In one or more embodiments, a pending request 110 is initially automatically labeled as “approval-required” at submission of the request, and may be updated to “auto-approve” only if necessary, as discussed below.

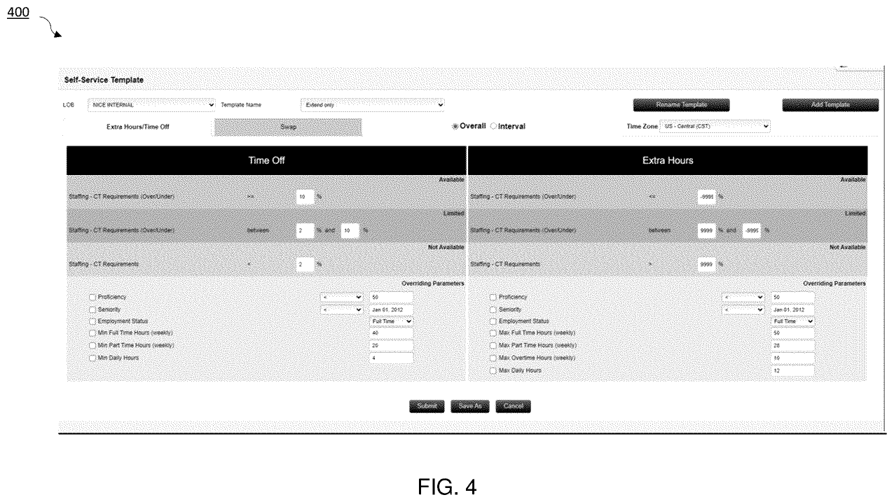

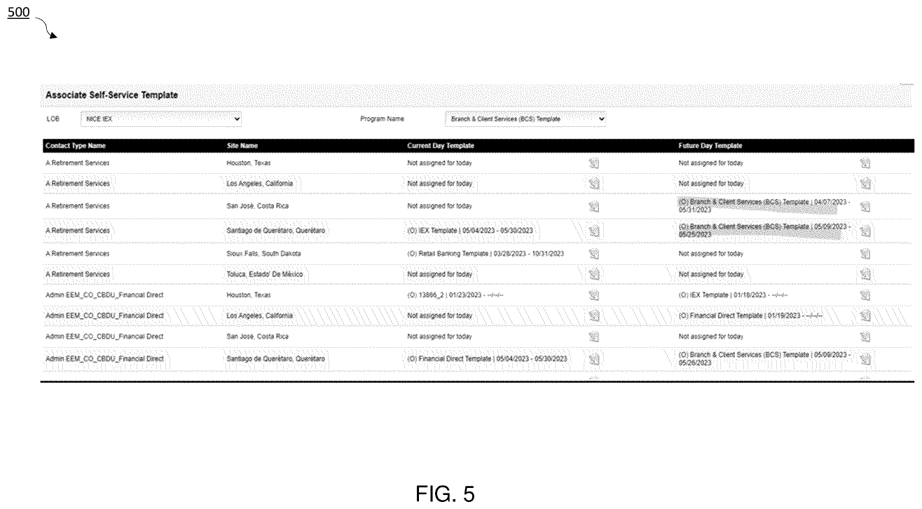

In one or more embodiments, a contact center shift schedule is a dynamic environment, with shift interval staffing fluctuating in real-time as new staffing situations 101 occur, such as, for example without limitation, contact center agents submit pending schedule change request(s) 110 in order to request time off or because they are unable to work a shift, while others request additional hours of work. Contact center supervisors and/or administrators may set various staffing threshold(s) 104 in advance to indicate when the availability status of a shift interval should be changed as shift interval staffing fluctuates over time. Staffing threshold(s) 104 may be configured by supervisors and/or administrators using self-service template 102, described in further detail in FIGS. 4 and 5 below.

Accordingly, the availability status of a shift interval may change over time as one or more new staffing situations 101 occur, affecting shift interval staffing. In some embodiments, the availability status of a shift interval may stay the same as one or more new staffing situations 101 occur if staffing threshold(s) 104 are maintained. In one or more embodiments, a new staffing situation 101 may occur based on operational parameters 103, a shift interval meeting automatic approval criteria 106, or both. In some embodiments, the availability status of a shift interval may change over time for one or more portions of the shift interval.

According to various embodiments, operational parameters 103 affecting staffing needs are monitored continuously by schedule management system 100. Operational parameters 103 may include for example without limitations, unplanned absenteeism, contact volume inflow, skills needed, understaffing, overstaffing, or any combination of such parameters. In some embodiments, monitoring operational parameters 103 may require, for example but without limitation to, monitoring the rate of incoming contacts to the contact center, tracking the absence of agents for shift times due to unforeseen circumstances, monitoring seasonal variations or special events such as local health issues and holidays, and/or other relevant factors that impact workforce requirements. In some embodiments, pending requests 110 may impact operational parameters 103 in terms of a shift interval becoming or staying at overstaffed or understaffed percentages. Changes in operational parameters 103 may affect the availability status of a shift interval if they cause changes in the ability of the shift interval to meet a staffing threshold 104.

In one or more embodiments, the availability status of a shift interval may change to full availability if the shift interval meets one or more of automatic approval criteria 106. In some embodiments, automatic approval criteria 106 for one or more shift intervals may be set by a contact center supervisor or administrator. For example, a supervisor may use a staffing threshold 104 to indicate full availability status for a shift interval that is sufficiently staffed such that any pending request 110 submitted during that interval may be automatically approved. In some embodiments, a supervisor may set automatic approval criteria 106 based on operational needs, such as contact inflow changes for example, to ensure any available agent can be auto-approved to work a shift interval that suddenly experiences high call volume. According to various embodiments, a contact center supervisor and/or administrator may use self-service template 102 to create and set automatic approval criteria 106. The creation and use of self-service template(s) 102 is discussed further in FIGS. 4 and 5 below.

In one or more embodiments, once the new staffing situation 101 arises, staffing algorithm 105 determines whether the new staffing situation 101 meets a current staffing threshold 104 such that the availability status of a shift interval has changed.

If the availability status of a shift interval has changed to become more available (e.g., no availability to limited or full availability, limited availability to full availability), availability algorithm 108 converts the approval type of any pending requests 110 submitted for that shift interval from “approval-required” to “auto-approve.” For example, a pending request 110 labeled as “approval-required” will be updated to “auto-approve” if the interval for which it is submitted has changed from limited availability status to full availability status, so that the pending request 110 can either automatically be approved or potentially be revised for automatic approval as discussed below. For example, if a contact center agent submits a time off request for shift interval 1:00:00 PM-8:00:00 PM, the request may initially require manual approval if the shift interval has limited availability. However, if a new staffing situation arises which meets a current staffing threshold for full availability, the agent's request may be auto-approved and the agent may be able to get their time off.

If the availability status of a shift interval has not changed, the approval type of any pending requests 110 submitted for that shift interval are not changed. For example, a pending request 110 labeled as “approval-required” will maintain that label if the interval for which it is submitted has not changed from limited availability status.

In various embodiments, one or more portions of shift intervals may change in availability status over time. For example, if a contact center agent submits a time off request for shift interval 1:00:00 PM-8:00:00 PM, the request may initially be labeled as “approval-required” if the shift interval has limited availability. However, if a new staffing situation arises for the portion of the shift interval from 1:00:00 PM-4:00:00 PM such that it meets a current staffing threshold for full availability (and the portion of the shift interval 4:00:00 PM-8:00:00 PM maintains limited availability), the agent's request may be revised to request a first time off request for shift interval 1:00:00 PM-4:00:00 PM that availability algorithm 108 will convert to auto-approve type, and a second time off request for shift interval 4:00:00 PM-8:00:00 PM that may be manually approved by a supervisor or administrator. The original pending request submitted by the agent for shift interval 1:00:00 PM-8:00:00 PM may be cancelled to avoid scheduling confusion.

Availability algorithm 108 then compares any pending request(s) 110 it has identified as “auto-approve” type (identified pending schedule change request(s) 120, also referred to as “identified request(s) 120”) with automatic approval criteria 106, to determine whether identified request(s) 120 may be automatically approved. In one or more embodiments, identified request(s) 120 may meet one or more of the automatic approval criteria 106, and identified request(s) 120 may be automatically approved. In some embodiments, identified request(s) 120 may not meet one or more of the automatic approval criteria 106, and may be revised to meet one or more automatic approval criteria 106. In some embodiments, identified request(s) 120 may not meet one or more of the automatic approval criteria 106, and may not be able to be revised to meet one or more automatic approval criteria 106, in which case identified request(s) 120 may be cancelled.

In one or more embodiments where identified request(s) 120 may not meet one or more of the automatic approval criteria 106, and may be revised to meet one or more automatic approval criteria 106, availability algorithm 108 may generate and transmit a recommendation for the identified request(s) 120 (recommendation for identified pending schedule change request 125, also referred to as “recommendation for request 125”, i.e., a revised request) to the contact center agent(s) who submitted the identified request(s) 120. In some embodiments, generating recommendation for request 125 comprises generating revisions to the identified request 120 that would allow it to meet one or more automatic approval criteria 106. These revisions themselves comprise a change to the time range of the shift interval in the identified request 120. Portions of identified request 120 that do not meet automatic approval criteria 106 are retained as a separate pending request 110 or cancelled. For example, an agent's extra hours identified request 120 is to work from shift interval 10:00:00 AM-1:00:00 PM, and a new staffing situation has occurred such that a portion of that interval, 10:00:00 AM-11:30:00 AM has full availability while the other portion, 11:30:00 AM-1:00:00 PM has no availability. In this situation, recommendation for request 125 would include a revision to identified request 120 to request extra hours for the 10:00:00 AM-11:30:00 AM interval. The portion of identified request 120 requesting the 11:30:00 AM-1:00:00 PM interval would be cancelled or require manual approval. If the 11:30:00 AM-1:00:00 PM interval had limited availability, that portion of the identified request 120 would be retained as a separate, second pending request 110 with an “approval-required” label for manual supervisor review.

In one or more embodiments, once recommendation for request 125 is generated and transmitted to the appropriate contact center agent for review, the agent may either approve or decline all or a portion of the recommendation for request 125. If schedule management system 100 receives an approval of all or a portion of the recommendation for request 125 from the agent, all or the approved portion of the recommendation for 125 may be automatically approved for the shift interval. Any portions of recommendation for request 125 not approved by, or declined by the agent are cancelled or may require manual approval. The identified request to work (in the above example the request to work from shift interval 10:00:00 AM-1:00:00 PM) is canceled.

According to various embodiments, anytime a pending request 110, identified request 120, and/or recommendation for request 125 is cancelled, approved, or auto-approved, either in part or in full, pending schedule change request status 130 of the cancelled, approved, or auto-approved request is updated. In some embodiments, pending schedule change request status 130 may also take into account different statuses of portions of a request as the staffing schedule changes over time.

Accordingly, anytime pending schedule change request status 130 is updated, scheduling database 112 is updated to reflect the change in schedule based on the approval or cancellation of the underlying request(s) or portion(s) of the request(s). The schedule of the contact center agent who submitted the underlying request(s) (agent schedule 114) is also updated to reflect any schedule changes based on the approval or cancellation of the underlying request(s) or portion(s) of the request(s). A schedule notification 116 is sent to the agent as well to notify them of any schedule changes based on the approval or cancellation of the underlying request(s) or portion(s) of the request(s). In one or more embodiments, schedule notification 116 may be sent via web, mobile, and/or email notification. In some embodiments, schedule notification 116 may also be sent to one or more contact center supervisors and/or administrators.

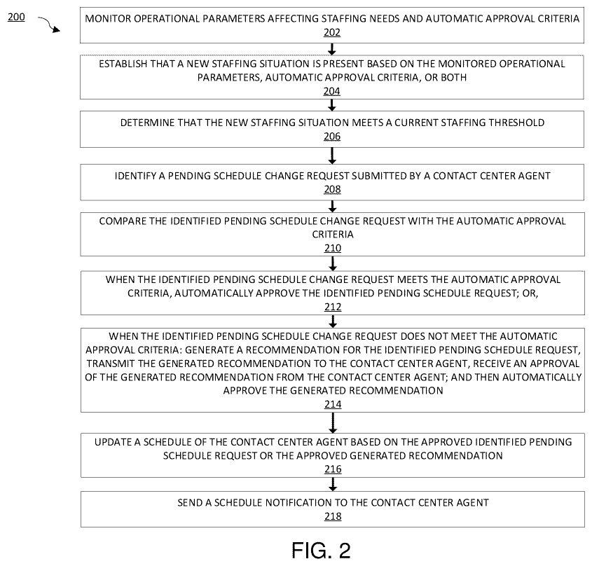

FIG. 2 is an exemplary flowchart 200 for schedule change management according to embodiments of the present disclosure. Note that one or more steps, processes, and methods described herein of flowchart 200 may be omitted, performed in a different sequence, or combined as desired or appropriate based on the guidance provided herein. Flowchart 200 of FIG. 2 includes operations for schedule change management, as discussed in reference to FIG. 1. One or more of steps 202-210 of flowchart 200 may be implemented, at least in part, in the form of executable code stored on non-transitory, tangible, machine-readable media that when run by one or more processors may cause the one or more processors to perform one or more of steps 202-210. In some embodiments, flowchart 200 can be performed by one or more computing devices discussed in schedule management system 100 of FIG. 1.

Accordingly, at step 202 of flowchart 200, schedule management system 100 monitors operational parameters 103 affecting staffing needs and automatic approval criteria 106 to determine whether the availability status of a shift interval has changed. In one or more embodiments, operational parameters may include, but are not limited to, one or more of unplanned absenteeism, contact volume inflow, skills needed, understaffing, overstaffing, or any combination thereof. In some embodiments, monitoring operational parameters 103 may include tracking incoming pending requests 110 for changes in shift interval staffing percentages. According to various embodiments, a contact center supervisor and/or administrator may use self-service template 102 to create and set automatic approval criteria 106. The creation and use of self-service template(s) 102 is discussed further in FIGS. 4 and 5 below.

At step 204 of flowchart 200, schedule management system 100 establishes that a new staffing situation 101 is present based on the monitored operational parameters 103, a shift interval meeting automatic approval criteria, or both.

At step 206 of flowchart 200, staffing algorithm 105 determines whether the new staffing situation 101 meets a current staffing threshold 104 such that the availability status of a shift interval has changed. In one or more embodiments, the current staffing threshold 104 is set by a contact center supervisor through a self-service template 102. The creation of self-service template 102 is discussed further in FIGS. 4 and 5 below.

At step 208 of flowchart 200, if staffing algorithm 105 determines that the new staffing situation 101 meets the current staffing threshold 104 such that the availability status of a shift interval has changed to become more available, a pending schedule change request 110 submitted by a contact center agent is identified (identified pending schedule change request 120, also referred to as “identified request(s) 120”).

At step 210 of flowchart 200, availability algorithm 108 compares identified request 120 with automatic approval criteria 106. In one or more embodiments, automatic approval criteria 106 is set by a contact center supervisor through a self-service template 102. The creation of self-service template 102 is discussed further in FIGS. 4 and 5 below.

Accordingly, at step 212 of flowchart 200, when identified request 120 meets automatic approval criteria 106, identified request 120 is automatically approved.

At step 214 of flowchart 200, when identified request 120 does not meet the automatic approval criteria 106 but may be revised to meet one or more automatic approval criteria 106, a recommendation for the identified pending schedule change request 125 (also referred to as “recommendation for request 125”) may be generated. In some embodiments, the recommendation for request 125 is generated by generating revisions to identified request 120 such that it would meet automatic approval criteria 106. These revisions to identified request 120 comprise a change to the time range of the shift interval in identified request 120. The recommendation for request 125 is then transmitted to the contact center agent that submitted identified request 120. In one or more embodiments, the schedule change management system 100 may receive an approval of the recommendation for request 125 from the contact center agent, at which point the schedule change management system 100 may automatically approve the recommendation for request 125.

In one or more embodiments, a recommendation for request 125 may not be able to be generated such that identified request 120 would meet automatic approval criteria 106. In this case, identified request 120 may still require manual approval by a supervisor or may be cancelled.

In some embodiments, the schedule change management system 100 may not receive an approval from the contact center agent for recommendation for request 125, and identified request 120 may be still require manual approval by a supervisor. When schedule change management system 100 does receive approval from the contact center agent of the recommendation for request 125, identified request 120 may be canceled.

At step 216 of flowchart 200, the schedule of the contact center agent that submitted identified request 120 is updated, based on the approved identified request 120 or the approved recommendation for request 125.

At step 218 of flowchart 200, a schedule notification via web, mobile, and/or email notification is sent to the contact center agent to inform them of the updated schedule. In one or more embodiments, a web, mobile, and/or email schedule notification is sent to the contact center supervisor as well. In some embodiments, the schedule database may be updated as well.

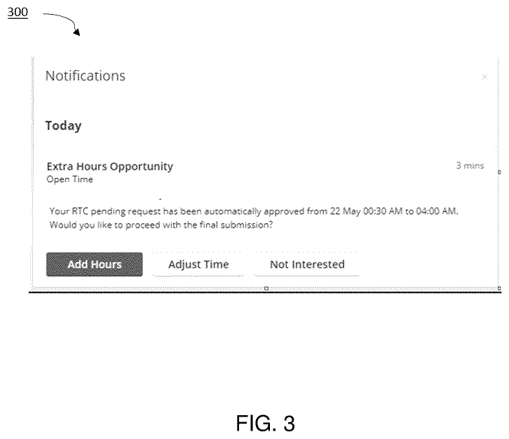

FIG. 3 is an exemplary user interface 300 for interacting with the recommendation for identified pending schedule change request 125 (also referred to as “recommendation for request 125”) generated with revisions to allow for auto-approval and transmitted to the contact center agent, according to some embodiments. Interface 300 may be a view available to agents to assess the recommendation for request 125 and approve or decline all or portions of the recommendation for request 125.

In one or more embodiments, recommendation for request 125 may comprise scheduling the agent for additional time than what the agent originally requested. In some embodiments, the recommended pending schedule change request may comprise scheduling the agent for less time than what the agent originally requested. The agent may use one or more of the buttons on interface 300 to accept recommendation for request 125, adjust the interval of recommendation for request 125 to approve a portion of recommendation for request 125, or decline recommendation for request 125.

FIG. 4 is an exemplary user interface 400 for configuring a self-service template, such as self-service template 102 in FIG. 1. Interface 400 may be a view available to contact center supervisors and/or administrators to configure one or more staffing thresholds, such as staffing threshold 104 in FIG. 1, and/or automatic approval criteria, such as automatic approval criteria 106 in FIG. 1. In some embodiments, a contact center supervisor or administrator may use various staffing thresholds to set automatic approval criteria by indicating a staffing threshold for a shift interval to have full availability status. In one or more embodiments, staffing thresholds may be set up, for example but not limited to, time off requests and/or extra hours requests from contact center agents.

For time off requests, staffing thresholds may be set up to allow time off schedule change requests to have no availability status, limited availability status (requiring manual approval), or full availability status (allowing for auto-approval) based on various percentages of staffing requirements that a contact center supervisor can input using interface 400. For example, in FIG. 4, the contact center supervisor has configured the template such that when an agent submits a time off request for a shift interval, if the interval has greater than or equal to 10% of its staffing requirement met, the time off request may have full availability status. In the same example, if the interval has between 2% and 10% of its staffing requirement met, the time off request may have limited availability status. Finally, if the interval has less than 2% of its staffing requirement met, the time off request will not be available for approval. In one or more embodiments, the staffing requirement of a shift interval may be a predetermined value set by the contact center, contact center supervisors, and/or contact center administrators, such as for a given day or a given range of days. For example, the staffing requirement for intervals around a holiday period may be set higher due to greater expected absenteeism or due to greater anticipated customer call volume.

Similarly, for extra hours requests, a contact center supervisor may input staffing thresholds to allow extra hours requests to have no availability status, limited availability status (requiring manual approval), or full availability status (allowing for auto-approval) based on various percentages of staffing requirements that the contact center supervisor can input using interface 400. For example, in FIG. 4, the contact center supervisor has configured the template such that when an agent submits an extra hours request for a shift interval, if the interval has less than or equal to −9999% of its staffing requirement met, the time off request may have full availability status. In the same example, if the interval has between 9999% and −9999% of its staffing requirement met, the extra hours request may have limited availability status. Finally, if the interval has more than 9999% of its staffing requirement met, the extra hours request will not be available for approval. In one or more embodiments, the staffing requirement of a shift interval may be a predetermined value set by the contact center, contact center supervisors, and/or contact center administrators.

In one or more embodiments, a contact center supervisor may also be able to input one or more overriding parameters to determine the availability status of a pending schedule change request regardless of, or in addition to, the staffing threshold settings. Such parameters include, but are not limited to, agent proficiency, seniority, employment status, maximum full time hours (weekly) maximum part time hours (weekly), maximum overtime hours (weekly), and maximum daily hours.

FIG. 5 is an exemplary user interface 500 for a contact center supervisor or administrator to view configured self-service templates, according to some embodiments. As shown, user interface 500 displays self-service templates by contact-type and site such that multiple shift intervals may be tagged as full availability, limited availability, or no availability status based on staffing thresholds and/or overriding parameters. This is an alternative view that is presented to supervisors and administrators to define, schedule, and activate one or more self-service templates over a given timeframe either in real-time or scheduled for a future time interval.

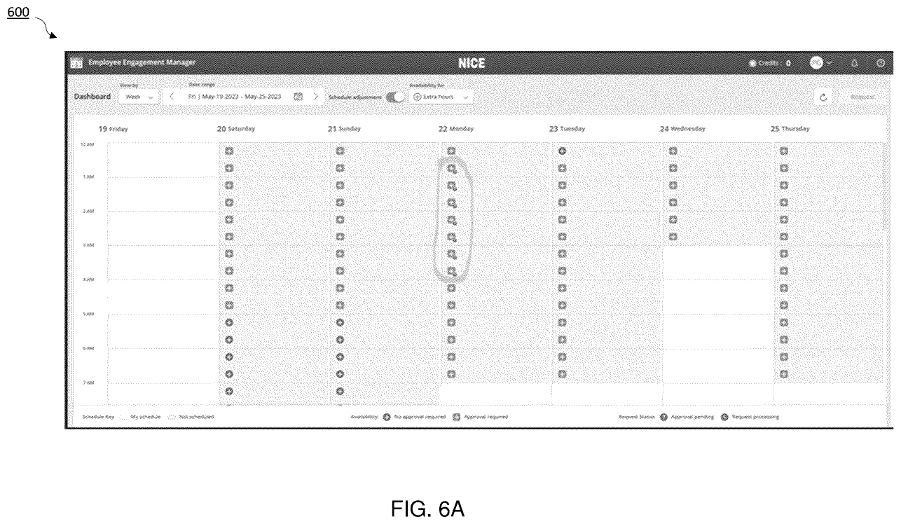

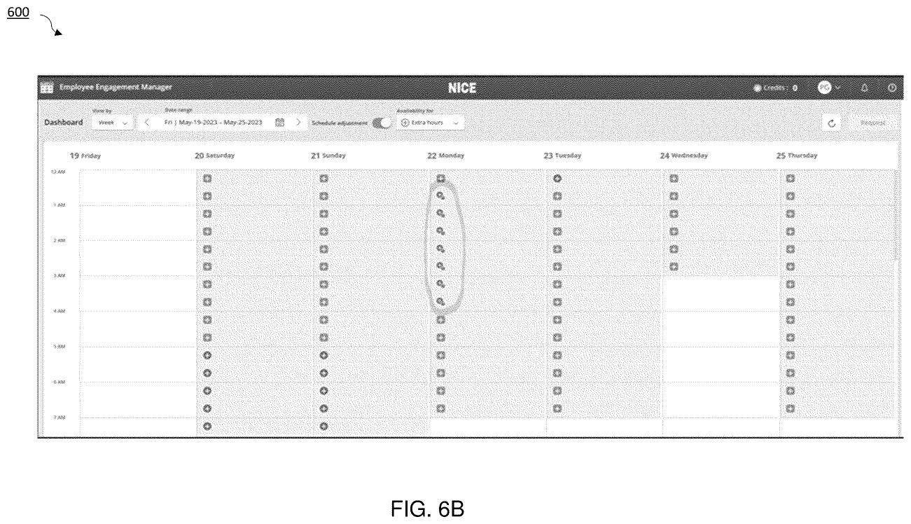

FIG. 6A is an exemplary user interface 600 for a contact center supervisor or administrator to view shift interval data in schedule management system 100 as displayed in FIG. 1. As shown, user interface 600 displays the availability status of shift intervals in a user-defined date range. In one or more embodiments, the availability status of a shift interval may be indicated by displaying icons of various colors or including various symbols to represent full, limited, or no availability.

For example, in FIG. 6A, the availability statuses of shift intervals from May 19, 2023-May 25, 2023 are displayed, specifically in terms of availability for a contact center agent to submit an additional hours request. In this example, blue icons with a plus sign symbol indicate limited availability, while green icons with a plus sign symbol indicate full availability. The circled shift intervals on Monday, May 22 indicate that those intervals have limited availability based on current data in schedule management system 100. In one or more embodiments, the availability-indicating icon of a shift interval may change over time as the availability status of the shift interval changes in response to changes in staffing requirements of the shift interval.

FIG. 6B is exemplary user interface 600 after a new staffing situation 101 as shown in FIG. 1 has occurred. In this example, the new staffing situation 101 has caused the circled intervals on Monday, May 22 to meet the staffing threshold for full availability. Accordingly, the availability-indicating icons have now changed to green icons with a plus sign symbol to indicate full availability of those shift intervals.

Below are examples of full data structures usable with the present disclosure.

| | |
|---|---|
| 1. | Algorithm to check if new staffing situation met staffing threshold |
| | If (new staffing threshold >= staffing threshold from template) |
| | True |
| | Otherwise |
| | False |
| 2. | Scheduler to Process Pending Schedule Change Requests |
| | run(pendingRequests): |
| | for each request in pendingRequests: |
| | // Step 2.1: Check Auto-Approve Eligibility |
| | if isEligibleForAutoApproval(request): |
| | // Step 2.2: Provide System Recommendation |
| | recommendation = getRecommendation(request) |
| | // Step 2.3: Agent's Response |
| | agent = new Agent( ) |
| | revisedRequest = agent.reviewAndRevise(request, recommendation) |
| | if revisedRequest is not null: |
| | // Step 2.4: Auto-Approve and Cancel Original Request |
| | auto ApproveAndCancel(request, revisedRequest) |
| | // Step 3: Notify the Agent and Update System |
| | updateStatus(pendingRequests) |
| | isEligibleForAutoApproval(request): |
| | //In this method will be implemented logic for the auto-approve eligibility |
| | criteria |
| | return true if request is eligible, otherwise false |
| | getRecommendation(request): |
| | // Implement the system recommendation logic here |
| | return recommendation based on request evaluation |
| | autoApproveAndCancel(originalRequest, revisedRequest): |
| | // Mark the originalRequest as auto-approved and cancel it in the system |
| | updateStatus(requests): |
| | // Update the status of each request in the system (auto-approved or pending) |

Where applicable, various embodiments provided by the present disclosure may be implemented using hardware, software, or combinations of hardware and software. Also, where applicable, the various hardware components and/or software components set forth herein may be combined into composite components including software, hardware, and/or both without departing from the spirit of the present disclosure. Where applicable, the various hardware components and/or software components set forth herein may be separated into sub-components including software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

Although illustrative embodiments have been shown and described, a wide range of modifications, changes and substitutions are contemplated in the foregoing disclosure and in some instances, some features of the embodiments may be employed without a corresponding use of other features. One of ordinary skill in the art would recognize many variations, alternatives, and modifications of the foregoing disclosure. Thus, the scope of the present application should be limited only by the following claims, and it is appropriate that the claims be construed broadly and in a manner consistent with the spirit and full scope of the embodiments disclosed herein.

The Abstract at the end of this disclosure is provided to comply with 37 C.F.R. § 1.72(b) to allow a quick determination of the nature of the technical disclosure. It is submitted with the understanding that it will not be used to interpret or limit the scope or meaning of the claims.

What is claimed is:

1. A schedule change management system comprising:
at least one processor and a computer readable medium operably coupled thereto, the computer readable medium comprising a plurality of instructions stored in association therewith that are accessible to, and executable by, the at least one processor, to perform operations which comprise:
monitoring operational parameters affecting staffing needs and automatic approval criteria;
establishing that a new staffing situation is present based on the monitored operational parameters, automatic approval criteria, or both;
determining that the new staffing situation meets a current staffing threshold;
identifying a pending schedule change request submitted by a contact center agent;
comparing the identified pending schedule change request with the automatic approval criteria:
when the identified pending schedule change request meets the automatic approval criteria, automatically approving the identified pending schedule change request; or,
when the identified pending schedule change request does not meet the automatic approval criteria:
generating a recommendation for the identified pending schedule change request;
transmitting the generated recommendation to the contact center agent;
receiving an approval of the generated recommendation from the contact center agent; and
then automatically approving the generated recommendation;
updating a schedule of the contact center agent based on the approved identified pending schedule change request or the approved generated recommendation; and
sending a schedule notification to the contact center agent.

2. The schedule change management system of claim 1, wherein the operational parameters comprise one or more of unplanned absenteeism, contact volume inflow, skills needed, understaffing, overstaffing, or any combination thereof.

3. The schedule change management system of claim 1, wherein generating a recommendation for the identified pending schedule change request comprises generating revisions to the identified pending schedule change request to meet the automatic approval criteria.

4. The schedule change management system of claim 3, wherein the revisions comprise a change to a time interval range in the identified pending schedule change request.

5. The schedule change management system of claim 1, wherein, when the identified pending schedule change request does not meet the automatic approval criteria, the operations further comprise canceling the identified pending schedule change request.

6. The schedule change management system of claim 1, wherein the operations further comprise sending the schedule notification to a supervisor of the contact center agent.

7. The schedule change management system of claim 1, wherein, when the identified pending schedule change request meets the automatic approval criteria, the operations further comprise changing a status of the identified pending schedule change request to automatically approved.

8. A method of schedule change management, comprising:
monitoring operational parameters affecting staffing needs and automatic approval criteria;
establishing that a new staffing situation is present based on the monitored operational parameters, automatic approval criteria, or both;
determining that the new staffing situation meets a current staffing threshold;
identifying a pending schedule change request submitted by a contact center agent;
comparing the identified pending schedule change request with the automatic approval criteria:
when the identified pending schedule change request meets the automatic approval criteria, automatically approving the identified pending schedule change request; or,
when the identified pending schedule change request does not meet the automatic approval criteria:
generating a recommendation for the identified pending schedule change request;
transmitting the generated recommendation to the contact center agent;
receiving an approval of the generated recommendation from the contact center agent; and
then automatically approving the generated recommendation;
updating a schedule of the contact center agent based on the approved identified pending schedule change request or the approved generated recommendation; and
sending a schedule notification to the contact center agent.

9. The method of claim 8, wherein the operational parameters comprise one or more of unplanned absenteeism, contact volume inflow, skills needed, understaffing, overstaffing, or any combination thereof.

10. The method of claim 8, wherein generating a recommendation for the identified pending schedule change request comprises generating revisions to the identified pending schedule change request to meet the automatic approval criteria.

11. The method of claim 10, wherein the revisions comprise a change to a time interval range in the identified pending schedule change request.

12. The method of claim 8, wherein, when the identified pending schedule change request does not meet the automatic approval criteria, further comprises canceling the identified pending schedule change request.

13. The method of claim 8, further comprising sending the schedule notification to a supervisor of the contact center agent.

14. The method of claim 8, wherein, when the identified pending schedule change request meets the automatic approval criteria, further comprises changing a status of the identified pending schedule change request to automatically approved.

15. A non-transitory computer-readable medium having stored thereon computer-readable instructions executable by at least one processor to perform operations which comprise:
monitoring operational parameters affecting staffing needs and automatic approval criteria;
establishing that a new staffing situation is present based on the monitored operational parameters, automatic approval criteria, or both;
determining that the new staffing situation meets a current staffing threshold;
identifying a pending schedule change request submitted by a contact center agent;
comparing the identified pending schedule change request with the automatic approval criteria:
when the identified pending schedule change request meets the automatic approval criteria, automatically approving the identified pending schedule change request; or,
when the identified pending schedule change request does not meet the automatic approval criteria:
generating a recommendation for the identified pending schedule change request;
transmitting the generated recommendation to the contact center agent;
receiving an approval of the generated recommendation from the contact center agent; and
then automatically approving the generated recommendation;
updating a schedule of the contact center agent based on the approved identified pending schedule change request or the approved generated recommendation; and
sending a schedule notification to the contact center agent.

16. The non-transitory computer-readable medium of claim 15, wherein the operational parameters comprise one or more of unplanned absenteeism, contact volume inflow, skills needed, understaffing, overstaffing, or any combination thereof.

17. The non-transitory computer-readable medium of claim 15, wherein generating a recommendation for the identified pending schedule change request comprises generating revisions to the identified pending schedule change request to meet the automatic approval criteria.

18. The non-transitory computer-readable medium of claim 15, wherein, when the identified pending schedule change request does not meet the automatic approval criteria, the operations further comprise canceling the identified pending schedule change request.

19. The non-transitory computer-readable medium of claim 15, wherein the operations further comprise sending the schedule notification to a supervisor of the contact center agent.

20. The non-transitory computer-readable medium of claim 15, wherein, when the identified pending schedule change request meets the automatic approval criteria, the operations further comprise changing a status of the identified pending schedule change request to automatically approved.
